(19) United States
(12) Patent Application Publication
(10) Pub. No.: US 2021/0206479 A1
(43) Pub. Date: Jul. 8, 2021

(54) Method for Improving Aircraft Engine Operating Efficiency

(71) Applicant: Borealis Technical Limited, North Plains, OR (US)

(72) Inventor: Isaiah W. Cox, London (GB)

(73) Assignee: Borealis Technical Limited, North Plains, OR (US)

(21) Appl. No.: 17/199,151

(22) Filed: Mar. 11, 2021

Related U.S. Application Data
(63) Continuation-in-part of application No. 15/441,555, filed on Feb. 24, 2017.
(60) Provisional application No. 62/299,475, filed on Feb. 24, 2016.

(51) Int. Cl. B64C 25/40; B64C 19/02; B64D 31/00

(52) U.S. Cl. CPC B64C 25/405; B64D 31/00; B64C 19/02

(57) ABSTRACT

A method is provided that extends available aircraft engine warm up and cool down times without extending total aircraft time on the ground. Aircraft that have engines with longer than average or longer than typical warm up and cool down times and are equipped with electric taxi systems are driven during hybrid taxi-out and taxi-in periods when the aircraft engines at lowest throttle settings are operating simultaneously with the electric taxi drive systems to move the aircraft during ground travel. The hybrid taxi-out and taxi-in periods ensure optimal steady, even warm up and cool down of engine components by takeoff and upon arrival and avoid thermally-induced structural deformations of engine components that adversely affect engines during flight. Aircraft engines may be designed to rely on the extended warm up and cool down times provided by the hybrid taxi periods without increasing aircraft ground travel time or negatively impacting airport operations.

### PRIORITY CLAIM

This application is a continuation-in-part of U.S. patent application Ser. No. 15/441,555, filed 24 Feb. 2017, which claims priority from U.S. Provisional Patent Application No. 62/299,475, filed 24 Feb. 2016, the disclosures of the foregoing applications being hereby fully incorporated herein by reference in their entireties.

### TECHNICAL FIELD

The present invention relates generally to producing improvements in operating efficiency and performance of aircraft engines and specifically to a method for providing extended engine warm-up and cool down time on the ground and improving the operating efficiency and performance of aircraft engines in aircraft equipped with electric taxi systems for autonomous ground movement.

### BACKGROUND OF THE INVENTION

Increasing aircraft engine operating efficiency and performance has many benefits. When aircraft engines operate with optimum efficiency during flight, not only is fuel saved, but engine life may also be extended. The frequency of required engine repairs and the cost of engine maintenance may also be reduced. A primary cause of engine damage that interferes with engine operating efficiency is associated with a reduction in the time available for warming up and cooling down the aircraft's engines when an aircraft is on the ground prior to takeoff and after landing. At busy airports in particular, airlines and/or airport operators try to keep aircraft on the ground for as little time as possible between landing and departure. The result of such pressures may leave less time for aircraft engine warm up and cool down than is desirable for long term engine operating efficiency.

Most commercial passenger aircraft are powered by two or more jet turbine engines with rotor blades mounted on a hub or shaft to rotate within a shroud or like housing structure that may have a static seal. A clearance between the tips of the turbine blades as they rotate within the shroud during engine operation must be maintained to avoid contact between the blade tips and the shroud or static seal. Engine performance parameters, including, for example, thrust, specific fuel consumption, and exhaust gas temperature margin, are dependent on the relationship between blade tips and shrouds or static seals circumferentially surrounding the blade tips. It is important to minimize blade tip clearance while avoiding rubs or other contact between the blade tips and the adjacent shroud or static seal. However, minimizing this clearance presents challenges. During engine operation, the turbine blade tip length from the hub or from an engine axis may increase or decrease at a different rate than the shroud can expand or contract to accommodate the changes in blade tip length. As a result, there may be insufficient blade tip clearance, and the blade tip may contact or rub the shroud or static seal, or there may be excess clearance. In the first instance, rotation of the turbine rotor may be adversely affected and the blade tip and/or shroud or static seal may be damaged, reducing the lives of these engine components. In the second instance, poor engine performance may result.

The clearance gap between the turbine blade tip, which may be referred to as the turbine tip seal gap, may have a dimension that is comparable to the width of a human hair. This clearance gap, which normally varies throughout an aircraft's flight, minimizes airflow losses and cools the turbine blades and shroud or engine casing and sealing structures when maintained at an optimum width. Tip clearance loss may account for a significant amount of engine airflow loss, potentially in the range of about 20% to 40%, depending on the engine type. When an optimum tight tip clearance gap is not maintained, the leakage airflow may induce unsteady heat loads onto the engine rotor casing, resulting in significant thermal stresses at the turbine blade tip.

Clearances between turbine blade tips and the shrouds or housings in which they rotate are affected by differences in the amounts and rates of thermal and mechanical expansion during engine operation. Mechanical expansion or growth is due to centrifugal force that occurs with changing speeds and pressures, with mechanical growth of the turbine blades and engine rotor being greater than that of the engine stator, which experiences greater thermal growth than the blades or rotor. Thermal growth of the turbine blades occurs more quickly than the thermal growth of either the engine stator or the rotor. Ideally, these different growths or expansions of the turbine blades and other engine components should be matched and as tight a clearance as possible maintained between the blade tips and shroud during engine operation.

It has been determined that the length of the turbine blade from the hub to the tip grows in proportion to the square of the rotor angular velocity and linearly with temperature. These results occur when fuel flow is increased, for example, as an aircraft climbs, during portions of its descent and landing sequence, or when the aircraft takes evasive action during flight. Active clearance control may be employed to maintain an optimum clearance between blade tips and the shroud during engine operation. Such processes may involve, for example, bathing the shroud in hot or cold air to cause the shroud to expand or contract as required to match thermal growth or contraction of the turbine blades during engine operation in flight. Control software has been developed to electronically monitor and control blade tip clearance, altering the gap between the blade tip and shroud as required to maintain an optimum clearance during engine operation. For example, U.S. Pat. No. 8,126,628 to Hershey et al. describes an example of an active clearance control system that electronically monitors blade tip clearance during flight and automatically adjusts tip clearance at an appropriate time before an engine command that changes the engine's rotational speed.

As noted, the time pressures exerted by airlines and airport operators to keep aircraft moving into and out of gates and taking off after a relatively short engine warm up time may result in adverse effects on engine operation in flight. An observed adverse effect that may affect all aircraft engines, and particularly affects models of engines that require a longer than typical or average warm up time, is known as rotor bow. This condition results from the differential thermal and mechanical expansion of the blades and rotors discussed above and causes the blade tips to rub against the shroud or casing walls because thermal bowing of the rotor has occurred. Rotor bow, or thermal bowing, may occur as a result of asymmetrical cooling after shut down of an engine on the previous flight. Differential thermal deformation of the material of the engine shaft section supporting the rotors as a result of temperature differences across the shaft causes the rotor axis to bend. The result may be an offset in the center of gravity of the bowed rotor and the clearance between the blade tips and the compressor or shroud wall. It has been recognized that all engines may display some degree of rotor bow. As discussed above, maintaining blade tip clearance as closely as possible to an optimal minimum clearance may have a critical impact on engine operating efficiency. When sufficient time is provided for an aircraft engine to be thoroughly warmed up prior to take off and slowly cooled down after landing, the rotor, shaft, and other engine components may be heated and cooled evenly so that differential thermal and mechanical expansion may be controlled and rotor bow is minimized and, ideally, eliminated.

There is clearly a tension in current airport and airline operations between moving aircraft as quickly as possible between landing and take off to minimize time aircraft spend on the ground so that airport use and aircraft flight cycles are maximized and providing adequate time on the ground for aircraft engines to be optimally warmed up prior to take off and cooled down after landing to maximize engine operating efficiency during flight. The art has not provided a solution to this dilemma.

### SUMMARY OF THE INVENTION

It is primary object of the present invention, therefore, to provide a method that provides optimal time required for aircraft to warm up and cool down engines with long warm up and cool down time requirements without increasing aircraft time on the ground or negatively impacting airport ground operations.

It is another object of the present invention to provide a method for moving an aircraft during ground travel that allows adequate time for controlled aircraft engine cool down and warm up after landing and prior to take off implemented in an aircraft with engines requiring long cool down and warm up times that are powered for ground movement by electric taxi systems.

It is another object of the present invention to provide a method for maximizing engine operating efficiency during flight by providing sufficient time to warm up and cool down aircraft engines so that differential thermal and mechanical expansion of engine components is controlled.

It is an additional object of the present invention to provide a method for extending aircraft engine run times before requiring take off thrust without increasing total aircraft time on the ground between landing and take off.

It is a further object of the present invention to provide a method for extending aircraft engine run times prior to take off and after landing that enables engines to be designed for and operated with longer warm up and cool down times than are currently required for most aircraft engines without adversely affecting airport operations.

It is a further object of the present invention to provide a method for the slow steady cool down of aircraft engines after landing that controls thermal properties of engine components while the aircraft is driven on the ground.

It is yet another object of the present invention to provide a method for minimizing or avoiding rotor bow in aircraft engines that are cooling down after landing that cools rotors with air supplied by an aircraft air source.

It is yet another object of the present invention to provide a method for providing adequate time for controlled aircraft engine cool down and warm up after landing and prior to take off without extending time required at a gate or for ramp operations.

In accordance with the foregoing objects, a method is provided for moving aircraft equipped with flight engines requiring long warm up and cool down times and with pilot-controllable electric taxi systems to drive aircraft during ground travel that increases engine operating efficiency during flight without increasing the time an aircraft spends on the ground between landing and take off. The equipped aircraft are driven only with the pilot-controllable electric taxi systems operating, simultaneously with both the electric taxi systems and the aircraft flight engines operating, or only with the aircraft engines operating at different times during aircraft ground travel after landing and prior to takeoff to ensure sufficient time for optimal aircraft engine warm up and cool down while the aircraft is kept moving on the ground.

When the electric taxi systems-equipped aircraft are cleared for departure, the electric taxi systems are activated and controlled to drive the aircraft forward, or reverse as required to push back, from a parking location to an engine start and warm up location where the flight engines may be safely started without the risks posed by jet blast or engine ingestion. The aircraft is driven during a period of hybrid taxi with the flight engines operating at a lowest throttle setting simultaneously with the electric taxi systems continuing operate to a threshold before a takeoff runway, where the hybrid taxi period ends. The electric taxi systems are then inactivated, and the aircraft continues to be driven with the flight engines set to operate at a higher throttle setting for take off. The hybrid taxi period provides sufficient time for the engines with longer warm up time requirements to warm up so that all for engine components are heated evenly. The hybrid taxi period enables an extended period of controlled engine warm up before the higher engine throttle setting is required, and the engine and engine components will be in an optimal thermal state prior to take off.

After landing, the aircraft flight engines continue to operate at a very low throttle setting selected to promote optimal cooling of the engines, and the electric taxi systems are simultaneously activated and controlled to drive the aircraft during a hybrid taxi period until the engines are cooled down and may be shut off. The aircraft is then driven with only the electric taxi systems to an airport parking location. Alternatively, the aircraft engines may be kept turning over slowly at a no throttle setting or while they are not operating and cooled with air supplied to the engine rotors from a source of air on the aircraft.

The present method not only accommodates the longer warm up and cool down requirements of some existing aircraft flight engines, but also enables aircraft engines to be designed to have longer warm up and cool down times than are presently required without increasing total time the aircraft spend on the ground, or otherwise adversely affecting airport operations.

### BRIEF DESCRIPTION OF THE DRAWINGS

FIG. 1 is a schematic view of a portion of an aircraft engine illustrating clearance between turbine blade tips and an adjacent shroud or casing that may or may not have a static seal or other seal element;

FIG. 2 is a diagrammatic view of an aircraft equipped with the engine of FIG. 1 and an electric taxi system mounted in the nose landing gear wheels of the aircraft;

FIG. 3 is a diagram of a ground travel path of an aircraft driven by an electric taxi system moving from a terminal parking location through push back to an engine start location where engine warm up begins to a take off location where the engine is optimally warmed up and the throttle setting may be increased prior to aircraft take off according to the method of the present invention; and

FIGS. 4A and 4B are flow charts that show steps of the method of the present invention that improves engine operating efficiency in flight of aircraft equipped with landing gear wheel-mounted electric taxi systems landing when extended warm up time and extended cool down time are provided during a hybrid taxi-out period and a hybrid taxi-in period when the aircraft are driven by simultaneously operating electric taxi systems and aircraft main engines at a zero throttle setting during the hybrid taxi periods to allow steady, even warm up and cool down of engine components.

### DESCRIPTION OF THE INVENTION

As discussed above, current airport ground operating procedures and the pressures resulting from minimizing aircraft time on the ground between landing and take off may not provide an optimum, or even a sufficient, amount of time to adequately warm up aircraft engines. An adequate engine warm up time prevents damage to engine components, for example rotor bowing, where distorted rotors cannot maintain optimum rotor blade tip clearance during flight. Engine operating efficiency during flight may be reduced when aircraft engine components are damaged or distorted as a result of an improperly warmed up or cooled down engine. Aircraft engine designers must presently design and configure aircraft engines to conform to engine start times imposed by airport operators. At most airports, the time between when both aircraft engines are started prior to take off and the subsequent application of a take off throttle setting is currently about 2.5 to 2.67 minutes (150 to 160 seconds), although engine start times may be shorter. While reduced engine start times may reduce aircraft time on the ground, this may be achieved at a cost in the form of uneven heating and differential thermal expansion of aircraft engine components.

When an aircraft engine is heated unevenly, one result of the differential thermal expansion of the rotor blade is rotor bowing and adverse contact between the blade tip and the engine casing or shroud. In addition, the optimum clearance gap between the blade tips and the casing or shroud that promotes airflow and enhances engine operating efficiency cannot be maintained. Consequently, engine performance suffers during flight and engine components, particularly rotors, casings, and seals, may need increased maintenance and frequent replacement. Providing sufficient time for an engine to optimally warm up and cool down in a manner that minimizes differential thermal expansion would both improve engine operating efficiency during flight and reduce engine maintenance and repair requirements.

When engines can be kept running on low throttle settings or off while aircraft are being moved to a terminal parking location after landing, engine cool down occurs more evenly so that rotor bow and other thermally-induced structural deformations may be avoided. The even cooling of aircraft engines that have been turned completely off after landing may be accomplished with cooling air from a source of air on the aircraft directed at the engine rotors to keep the rotors turning while the engines are off. Rotor bow may be avoided by keeping the rotors turning over slowly, even very slowly, while the rotors are cooled with airflow directed at them while they turn. One source of cooling air useful for this purpose may be bleed air from the aircraft's auxiliary power unit (APU). Other aircraft air sources may also be employed to provide cooling air, or a dedicated engine cooling air source may be provided.

Moving aircraft on the ground without thrust from main engines by using electric taxi systems has been proposed. Such systems employ electric motors that may be mounted to drive aircraft landing gear wheels during taxi and move the aircraft on the ground between landing and take off without operation of the aircraft's main engines, or autonomously. Typically, after an aircraft equipped with one or more electric taxi systems lands, the aircraft engines are shut down as soon as possible, the electric taxi systems are activated and controlled, and the aircraft is driven to a terminal gate or parking location with only the electric taxi systems. When the aircraft is cleared for departure, the electric taxi systems are activated and controlled to push back the aircraft, or move the aircraft forward out of a parking location, without external tow vehicles or operating engines, and the aircraft is driven with only the electric taxi systems to a take off location. The current state of the art is to start the aircraft main engines of an electric taxi systems-driven aircraft as late as possible before take off. When an aircraft is equipped with electric taxi systems, the art demonstrates that the goal is to shorten aircraft engine run times, primarily to avoid the adverse effects of jet blast and engine ingestion, as well as to minimize damage to engines from foreign object debris (FOD). Other benefits of shortened engine run time may be reductions in fuel use, noise and atmospheric pollution. However, when the running time of aircraft engines is shortened as described, especially the running time of the types of engines that may require longer warm up and/or cool down times, the likelihood of uneven heating of engine components and the differential thermal expansion of those components described above is guaranteed, as are the resulting deviations from the required optimal blade tip clearance.

The method of the present invention is most effectively performed using aircraft equipped with electric taxi systems, such as, for example, the electric taxi systems developed by the present inventor. Such systems are identified by the name WHEELTUG® and are described, for example, in commonly owned U.S. Pat. Nos. 7,975,960; 9,022,316; 9,033,273; and 9,511,853, among others. The disclosures of the foregoing patents are fully incorporated herein by reference. The present method may also be used by aircraft equipped with other electric taxi systems known in the art. These electric taxi systems may move aircraft efficiently during ground travel and operations and provide significant turnaround time savings compared to aircraft moved during ground travel only with aircraft engines. The present method incorporates the significant time savings possible when aircraft are driven on the ground with electric taxi systems with simultaneously providing sufficient time for aircraft engines, especially those with longer than average warm up and cool down time requirements, to warm up and cool down in a manner that prevents engine damage from adverse thermal stresses.

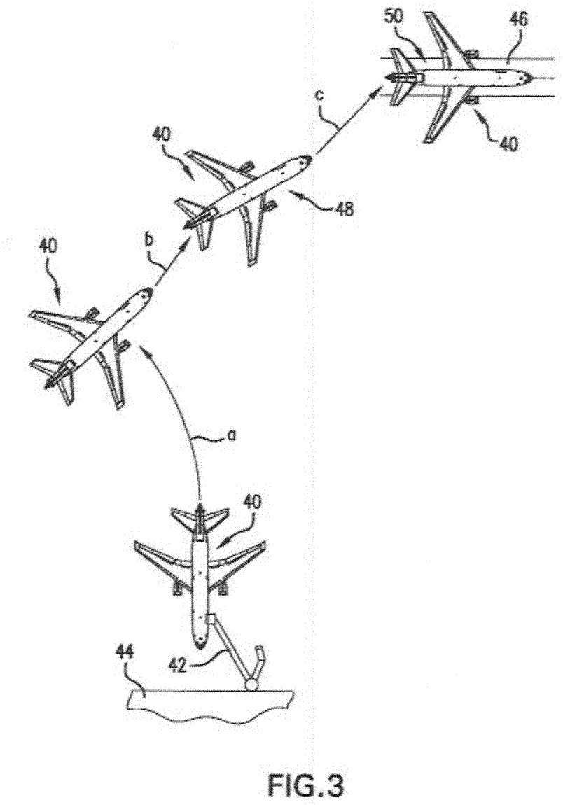

The terms “aircraft engines,” “aircraft main engines,” and “aircraft flight engines” are used interchangeably to indicate an aircraft's engines, such as engines 32 and 34 on aircraft 30 in FIG. 2, that power flight of the aircraft and may be used as described herein to move the aircraft on the ground. These engines are turbofan jet engines that are used to power commercial narrow body aircraft. Some legacy versions of these aircraft engines, for example the CFM56, made by CFM International, may warm up in about 45 to 50 seconds and the Pratt & Whitney V2500 may take about 2.5 to 2.67 minutes (150 to 160 seconds) to warm up. However, the newer generation of turbofan engines require longer warm up times than the legacy engines. The CFM LEAP series of aircraft engines requires a warm up time greater than 3 to 4 minutes. Geared turbofan aircraft engines introduced by Pratt & Whitney, for example the PW1100G, required about 6 minutes (350 seconds) to warm up. As used herein, aircraft engines with “longer” and “longer than average start times” refer to this newer generation of turbofan and geared turbofan engines with engine warm up times that are on the order of minutes longer than the sub-minute warm up times for the previous generation of legacy aircraft engines.

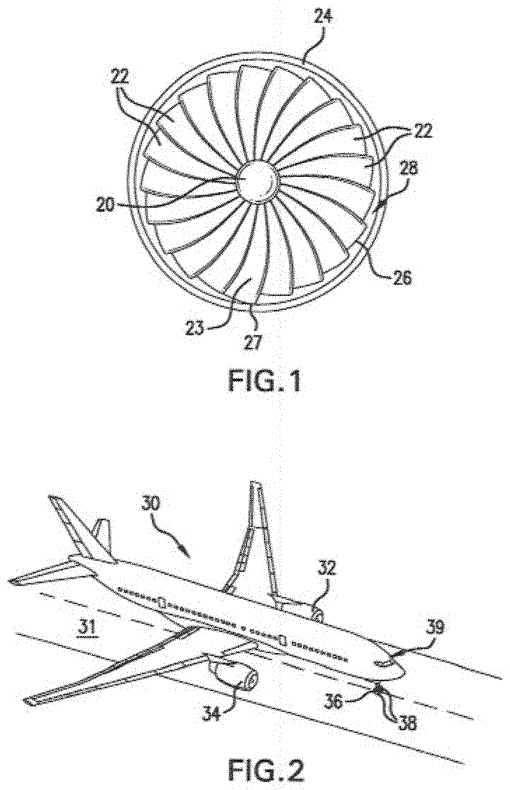

Referring to the drawings, which are not drawn to scale, FIG. 1 is a schematic diagram of a portion of an aircraft engine showing a central hub 20 supporting a number of circumferentially mounted rotors or turbine blades 22 mounted for rotational movement during engine operation within a casing or shroud 24. Each blade 22 has a tip 26 that should be spaced inwardly of the casing or shroud 24 to maintain a clearance gap 28 between the blade tip 26 and the casing 24. As noted above, a tight clearance gap 28, which may be as small as in the range of the width of a human hair, is maintained between the blade tip and the casing. Clearance gaps may be expressed as a percentage of the blade length, such as less than 0.5% of the blade length for a tight clearance and 0.1% and 0.2% of the blade length for very tight clearances. The optimum clearance gap may vary for different manufacturers' engines. One of the rotor blades 23 shown in FIG. 1 exhibits rotor bow, as discussed above, and the tip 27 of blade 23 is shown directly contacting the casing or shroud 24 and will rub against the interior of the casing as the rotor 23 rotates on the hub 20 during engine operation.

FIG. 2 is a schematic drawing of an aircraft 30 equipped with an electric taxi system for use in the present method as it is driven on a runway or taxiway 31 during taxi-out or during taxi-in. The aircraft 30 is shown with two jet engines 32 and 34, one mounted on each wing. Other aircraft may have additional numbers of engines. Each of the engines will include the blades 22 in a casing or shroud 24 as shown in FIG. 1 that will require an optimum clearance gap 28 to be maintained during engine operation to ensure optimum airflow for efficient engine operation. The engines 32 and 34 on aircraft 30 may be the newer generation turbofan and/or geared turbofan engines that require the longer warm up times described above, such as, for example without limitation, the CFM LEAP, the Pratt & Whitney 1100G, and similar aircraft engine models that have warm up times in the range of 3 to 4 minutes and longer.

The aircraft may additionally have one or more electric taxi systems 36, such as those referred to in the above-listed patents, that include electric drive motors mounted within one or more nose or main landing gear wheels. The electric drive motors may be activated and controlled to move the nose or main landing gear wheels in which they are mounted at a desired speed or torque and, therefore, to drive the aircraft on the ground with operation of and without operation of the main engines or external tow vehicles. In FIG. 2, two electric taxi systems 36 are mounted within each of the two nose landing gear wheels 38. The main landing gear wheels are not visible; however, one or more electric taxi systems could also be operationally mounted within one or more of the main landing gear wheels to drive the main landing gear wheels. The electric taxi systems 36 may include dedicated pilot controls (not shown) in the cockpit 39 connected to activate and drive the drive motors. Power for the electric drive motors may be supplied by a suitable source of electric power that may include the aircraft auxiliary power unit, as well as other usable sources of electric power that can be located on the aircraft. The electric taxi systems 36 may be controlled by the pilot and/or cockpit crew to drive the aircraft on the ground with thrust and without thrust from the aircraft's main engines between landing and take off and at other times when it is necessary to move the aircraft 30 on the ground.

The use of electric taxi systems, such as the nose landing gear wheel-mounted electric taxi systems 36, to drive aircraft during ground operations has heretofore been suggested to reduce aircraft fuel use and to reduce the time aircraft engines may be required to operate during aircraft ground travel. One of the significant benefits of employing an electric taxi system to move aircraft during ground travel is the time savings that are possible. Moving an aircraft on the ground, particularly into and out of a congested airport ramp area, may be done more quickly, efficiently, and safely with electric taxi systems than with thrust from aircraft engines. In addition, since external tow vehicles are not required to move electric taxi system-driven aircraft during push back or at other times, the time required to attach and detach a tow vehicle can be eliminated from the time these aircraft spend on the ground between landing and take off. Reducing the time aircraft spend on the ground may amount to significant cost savings for airlines. Reducing aircraft time on the ground, which increases time when aircraft can be in the air, saves time, a core driver for why people fly. Aircraft engines can operate at a zero throttle setting and idle safely and for a longer time during hybrid taxi with engines operating simultaneously with electric taxi systems in accordance with the method of the present invention. Overall aircraft operating costs may be reduced. Paradoxically, running aircraft engines at a zero throttle setting to idle for longer times than is currently done reduces both costs attributed to engine wear associated with thermal issues and costs attributed to higher aircraft utilization.

The present method enables airlines to simultaneously realize the benefits of moving an aircraft with an electric taxi system and of extending the available warm up and cool down time for the aircraft's flight engines. The time when aircraft engines are running during ground operations may be extended with the present method, rather than shortened as with previously proposed electric taxi systems, so that sufficient time is available for the engines to optimally warm up and cool down more slowly and evenly than when engine running times are shortened.

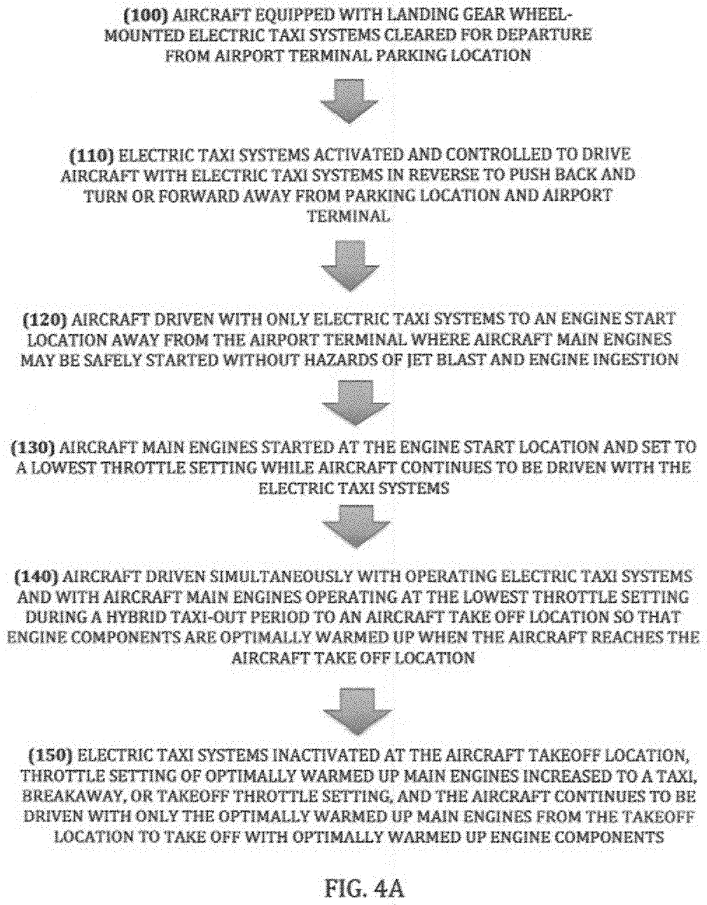

FIG. 3 is a diagram, not drawn to scale, that presents a representation of steps of the present method during and following push back that enable aircraft to take advantage of the time-saving benefits of ground movement controlled by an electric taxi system while simultaneously providing sufficient time for aircraft engines to warm up and cool down in a manner that controls differential thermal expansion of rotor blades and other engine components. An aircraft 40 is shown following a path from a parking location 42 at an airport terminal 44 to an assigned take off location on a runway 46. When the aircraft 40 is cleared for departure and push back, the aircraft pilot activates and controls the aircraft's one or more electric taxi systems 36 (FIG. 2) to drive the aircraft in a reverse direction away from the terminal 44, as shown by the arrow a. The aircraft 40 is turned by the electric taxi systems 36 to drive in a forward direction, represented by the arrow b. The aircraft pilot continues to control the electric taxi systems 36 to drive the aircraft 40 forward toward the assigned take off runway 46, along the general path represented by the arrow b, until the aircraft 40 reaches an engine start location 48 away from congestion near the terminal 44. The engine start location 48 is a location beyond the terminal 44 and out of terminal jet blast margins where it is safe to turn on the aircraft's main or flight engines without producing jet blast or causing engine ingestion.

At the engine start location 48, while the electric taxi systems remain operative and the aircraft continues to move, the aircraft main engines are turned on to a lowest throttle setting for the engine to start a hybrid taxi period. The risk of damage from FOD at the engine start location 48 is likely to be minimal, since vortices are not produced at the lowest engine throttle settings used during the hybrid taxi period. A throttle setting of about 30% or higher is generally required to produce vortices.

During the hybrid taxi period, the electric taxi systems are operating simultaneously with the aircraft main engines at a lowest throttle setting and moving the aircraft toward a take off location 50 on a runway 46. The lowest throttle setting for engines is designated zero (0). This is sufficient to produce idle thrust and will not produce vortices. The engines remain at the zero throttle setting and idle thrust during the hybrid taxi period as the aircraft 40 is driven simultaneously with the electric taxi systems and the engines at the zero throttle setting until the engines are warmed up. With the newer generation engines, the throttle cannot be advanced until the engines are warmed up. The length of the hybrid taxi period will depend on the warm up time for the specific type of engines on the aircraft. During the hybrid taxi period, the aircraft engines should warm up steadily, evenly, and safely as the aircraft is moved along the ground travel path with the simultaneously operating electric taxi systems and main engines.

The aircraft is driven during the hybrid taxi period along a path, represented by arrow c, to the take off location 50. At the take off location 50, the engines should be optimally warmed up, the electric taxi systems may be inactivated, the engine throttle setting may be increased, and the aircraft is moved on the ground with only the warmed up engines. If the aircraft is to take off at location 50, the engine throttle setting may be increased through a breakaway throttle setting of 40% to a take off throttle setting of 90% to 100%. It the aircraft needs to move past location 50 to a different take off location, the throttle setting may be increased to up to the 15% throttle setting for normal taxiing until the take off location is reached where the throttle setting will be increased to the take off throttle setting.

The distance between the engine start location 48 and the take off location 50, represented by the arrow c, may be determined by the time required to sufficiently warm up the specific kind of turbofan engines on aircraft 40 to ensure that these engines are steadily and evenly warmed up prior to increasing the throttle setting. As noted, the optimal engine warm up time may vary for different turbofan engine designs, and the distance between engine start location 48 and the takeoff location 50 will also vary accordingly.

When the aircraft 40 takes off from the take off location 50 on runway 46, the engine should be optimally and evenly warmed up without differential thermal or mechanical expansion of rotor blades, blade tips, and other engine components. As a result, rotor bow and blade tip rubs due to differential thermal expansion of these structures, as shown and described in connection with FIG. 1, should not occur, and desired optimum blade tip clearances may be more easily maintained. When the engines have been warmed up as described, the aircraft should take off with the blade tips at or near an optimum clearance required for efficient engine operation. After the aircraft takes off, blade tip clearance may be automatically monitored during flight to maintain the optimum clearance gap for the aircraft's specific engines using methods known in the art.

The present method may also be employed to ensure that the kinds of turbofan aircraft engines described herein are evenly cooled down after landing during taxi-in. Engines remain on at a zero throttle setting while the pilot simultaneously activates and controls the electric taxi systems and drives the aircraft to a terminal parking location, such as parking location 42 (FIG. 3). Current landing procedures for aircraft with two engines, such as aircraft 30 with engines 32 and 34 (FIG. 2), may shut down one engine after landing. The other engine may move the aircraft at idle thrust and is then shut down when the aircraft reaches a gate or other parking location. With the present method, aircraft no longer have to rely on the engines for motive power to taxi-in since the electric taxi systems drive the aircraft. While the aircraft is being driven by the electric taxi systems, both engines may continue to run at a zero throttle setting, until the aircraft reaches its arrival destination or until optimal engine cooling has been achieved. Maintaining a zero throttle setting for the engines while the aircraft taxis in with simultaneously operating electric taxi systems ensures that a more predictable cooling and engine shut down routine may be implemented for the taxi-in procedure. Engine hardware and software may be adapted to function specifically for thrust operations with fewer compromises required for start up and shut down sequences. The method of the present invention enables a predictable, safer, and more consistent engine warm up and cool down in the engine software, with follow on benefits including decreased engine maintenance costs and increased engine efficiency and life span.

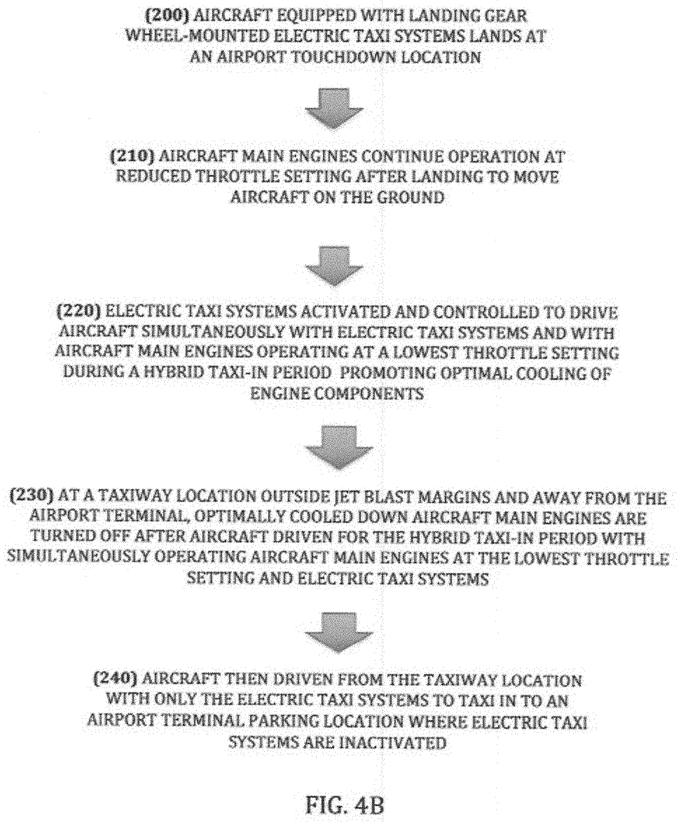

FIGS. 4A and 4B are flow charts that show steps of the method of the present invention that improves engine operating efficiency in flight of aircraft equipped with landing gear wheel-mounted electric taxi systems landing when extended warm up time and cool down time are provided during a hybrid taxi-out period and a hybrid taxi-in period when the aircraft are driven by simultaneously operating electric taxi systems and aircraft main engines at a zero throttle setting during the hybrid taxi periods to allow steady, even warm up and cool down of engine components without increasing aircraft total time on the ground. As discussed above, while the method of the present invention may be used to ensure optimal warm up and cool down for all kinds of aircraft engines, this method may be most effectively employed to ensure sufficient warm up time and cool down time when aircraft are powered in flight by the new generation of aircraft engines that have longer than average or longer than warm up times typically required for legacy engines. These new generation engine warm up times may be in the range of 3 to 6 minutes. Since, as noted, the throttle cannot be advanced until these newer engines are warmed up, the additional warm up time required increases the total time on the ground unless the hybrid taxi periods of the present invention are provided for aircraft with these newer engines.

FIG. 4A describes driving aircraft, including aircraft with the newer generation of main engines requiring longer warm up times, that are equipped with landing gear wheel-mounted electric taxi systems after the aircraft has been cleared for departure from an airport terminal parking location. (100) The electric taxi systems are activated and controlled to drive the aircraft in reverse to push back and turn or to drive the aircraft forward to drive away from the parking location and the aircraft terminal. (110) The aircraft is driven with only the electric taxi systems to an engine start location away from the terminal where the aircraft main engines may be started without the hazards produced by jet blast and engine ingestion. (120) The aircraft main engines are started at the engine start location while the aircraft continues to be driven with the electric taxi drive systems. (130) The aircraft is then driven simultaneously with operating electric taxi systems and with main engines operating at a lowest throttle setting during a hybrid taxi-out period to an aircraft takeoff location while engine components are undergoing an optimal steady and even warm up and are optimally warmed up when the aircraft reaches the aircraft take off location. (140) Th electric taxi systems are inactivated at the aircraft take off location, the throttle setting of the optimally warmed up engines is increased to a taxi, breakaway, or take off throttle setting, and the aircraft continues to be driven with only the optimally warmed up main engines from the take off location to take off with optimally warmed up engine components.

FIG. 4B describes driving an aircraft equipped with the landing gear wheel-mounted electric taxi systems and with the newer generation of engines requiring the longer warm up times after the aircraft lands at an airport. (200) The aircraft main engines continue operation engines at a reduced throttle setting to move the aircraft on the ground. (210) The electric taxi systems are activated and controlled to drive the aircraft simultaneously with aircraft main engines operating at a lowest throttle setting during a hybrid taxi-in period that promotes optimal cooling of engine components. (220) At a taxiway location away from the airport terminal, the optimally cooled down aircraft main engines are turned off after the aircraft has been driven for the hybrid taxi-in period with the simultaneously operating aircraft main engines and the electric taxi systems. (230) It is contemplated that the taxiway location will be a distance from the airport terminal and apron and outside jet blast margins where jet blast and engine ingestion associated with the main engines operating at a zero throttle setting will not pose any safety risks. The aircraft is then driven from the taxiway location with only the electric taxi systems to taxi in to an airport terminal parking location where the electric taxi systems are inactivated. (240)

When aircraft equipped with electric taxi drive systems and are moved simultaneously with aircraft main engines during hybrid taxi-out and taxi-in encounter ground travel conditions in which it is unsafe for the main engines to be operating, even at a zero throttle setting, the engines may be shut down and the aircraft can continue to be driven with the electric taxi systems. This may occur, for example, at an airport terminal or within safety margins beyond the terminal.

It is possible during hybrid taxi-out or hybrid taxi-in when the aircraft main engines are operating at a zero throttle setting simultaneously with operation of the electric taxi systems that a ground travel condition may be encountered in which the electric taxi system and the engine zero throttle setting are not able to keep the aircraft moving. This might occur if the aircraft must stop during ground travel, for example to move out of a runway depression or other ground surface condition. In that instance, the engine throttle setting may need to be increased to as high as 40% to move the aircraft out of the runway depression. Once the aircraft is moving, the throttle setting may be reduced to zero, and hybrid taxi can continue.

An alternative approach to cooling engines, as noted above, may be employed during taxi-in when the aircraft engines may be set to a zero throttle setting or turned off completely, and engine rotors and/or other rotating components may be rotated by directing a flow of cooling air at these structures to keep them rotating while the electric taxi system is driving the aircraft after landing during taxi-in. For example, bleed air from the APU aimed at rotating engine components can keep these components rotating so that they keep turning, even at a very slow rate, while cooling.

While the method described may require more fuel than shutting down the engines entirely when using only an electric taxi system to drive the aircraft during ground travel, it allows the airline to balance additional fuel consumption costs against engine maintenance costs. Further, the present method produces a reduction in overall fuel requirements, since the zero throttle settings used in conjunction with operation of the electric taxi system consume less fuel than when only one or more of the engines are propelling the aircraft. Engines given maximum time to optimally warm up prior to being set to a taxi, breakaway, or take off throttle setting and to optimally cool prior to being shut down completely operate with greater efficiency and produce corresponding maintenance savings. As discussed above, when thermal expansion of engine components occurs steadily and evenly, thermal and mechanical expansion can be matched, and an optimum clearance gap can be maintained between blade tips and the casing or shroud while the engine is operating during flight. Rotor bow can be eliminated, or at least significantly minimized.

With the present method of providing longer than currently available engine warm up and cool down times without increasing aircraft ground time, aircraft engines can be designed specifically to rely on simultaneous operation of electric taxi systems for hybrid taxi ground travel so that they may function optimally with these longer warm up and cool down times. Engines may be designed to require the longer warm up times possible with the present method, so that warm up time requirements on the order of 3 to 6 minutes or even longer may be implemented. Engine cool down times may also be extended to ensure a cooling time period that produces optimal cooling of engine components. Both of these outcomes may be achieved, moreover, without increasing total aircraft time on the ground or negatively impacting airport or airline operations. It is anticipated that the improvements in engine operating efficiency and maintenance reduction possible with the present method will extend beyond the rotors and casings or shrouds to rotor hubs and other related engine components.

It is additionally anticipated that aspects of the present method may be controlled automatically. For example, the determination of when to begin the engine warm up may be made using data that includes engine type, optimum blade tip clearance gap, engine warm up time requirements for the engine type, the distance between the engine start location and the aircraft take off location, engine cool down requirements for the engine type, the distance between an airport touchdown location and the taxiway location where engines are turned off, the ground speed of the aircraft driven by the electric taxi system, the travel route to or from the aircraft take off or airport touchdown location, and the like. Other aspects of the method may also be automated using appropriate data. Further, engine operating software may be modified to incorporate the longer warm up and cool down periods possible with the present method.

FIG. 3 shows a standard push back process in which an aircraft is driven in reverse from a nose-in orientation out of a terminal gate or parking location and turns, typically in the outer ramp area, to drive in a forward direction. Electric taxi systems may also be used to drive aircraft into and out of a terminal parking location in only a forward direction and to park either parallel to the terminal or at an optimum parking angle relative to the terminal to permit the simultaneous attachment of passenger loading bridges at gates to both forward and rear aircraft doors. The present method may be used with any of the foregoing aircraft parking arrangements to move an aircraft in either or both a forward and a reverse direction out of the airport ramp area to a safe location, such as the engine start location 48 in FIG. 3, where the engines may be safely turned on to the zero throttle setting that permits the engine to warm up evenly while the aircraft continues to be driven simultaneously with the electric taxi systems and the engines to the take off location, such as the take off location 50 in FIG. 3, where the electric taxi systems are inactivated and the engine throttle setting may be increased to a higher throttle setting for further taxi, breakaway, or take off prior to the aircraft taking off.

With the present method, aircraft engine designers may design engines specifically to rely on the capability provided to extend both warm up and cool down time when aircraft are equipped with pilot controllable electric taxi systems to power ground movement with and without simultaneously operating engines. Engine design and use may rely on the engine's integration with a simultaneously functioning electric taxi system to move an aircraft while the engine is running, but at a specifically designed low or very low throttle setting that facilitates the even, steady application or removal of heat from engine components. An engine may be designed with rotor blades and blade tips specifically configured within a casing or housing sized to promote symmetrical heating and cooling while maintaining an optimum clearance gap during engine warm up and cool down while the aircraft is driven on the ground with only the electric tax systems during push back or taxi-in. Other engine components, including, for example, the rotor shaft, that are subject to thermal deformation when temperatures of these components fluctuate and are not maintained at a steady level during engine operation may also be designed to conform to tolerances that may be different from those required in engines that must warm up or cool down quickly. Other aspects of aircraft engine design that avoids uneven or asymmetrical thermal expansion or contraction of engine components when extended engine warm up and cool down periods are available are also contemplated to be within the scope of the present method. When an engine's operating envelope is changed, which is the case with the required longer engine warm up time periods addressed by the present method, corresponding changes in engine hardware and software may be needed to ensure optimum efficiency of operation.

While the present invention has been described with respect to preferred embodiments, this is not intended to be limiting, and other arrangements, structures, and steps that perform the required functions are contemplated to be within the scope of the present invention.

### INDUSTRIAL APPLICABILITY

The present invention will find its primary applicability where it is desired to improve aircraft engine operating efficiency during flight without adversely impacting airport and airline ground operations, particularly when a longer than average or typical time period is required to warm up and/or cool down aircraft engines, and to ensure the optimal engine warm up and cool down needed to prevent engine damage from adverse thermal stresses.

1. A method that extends available engine warm up and cool down time during taxi and provides sufficient time for optimal engine warm up and cool down in aircraft powered by flight engines having longer than typical or average warm up time requirements and cool down time requirements without increasing total aircraft time on the ground, comprising:
a. equipping an aircraft with at least two turbofan engines having the longer than typical or average warm up time and cool down time requirements and mounting within landing gear wheels of the aircraft electric taxi systems operable to drive the aircraft without operating engines and operable to drive the aircraft simultaneously with the engines operating at a throttle setting to move the aircraft during ground travel;
b. moving the aircraft with only the electric taxi drive systems from an airport terminal parking location to an engine start location outside terminal jet blast margins, safely starting the engines while the electric taxi drive systems continue to move the aircraft, and operating the engines at a lowest engine throttle setting and promoting steady, even, steady warming of the engine components;
c. driving the aircraft with the electric taxi drive systems operating simultaneously with the engines operating at the lowest throttle setting during a hybrid taxi-out period to an aircraft take off location, the hybrid taxi-out period being determined by the longer than typical or average warm up time requirements of the turbofan engines;
d. inactivating the electric taxi drive systems and ending the hybrid taxi-out period at the aircraft take off location, increasing the engines throttle setting to a taxi, breakaway, or take off throttle setting, and continuing to move the aircraft with only the operating engines at the taxi, breakaway, or take off throttle setting required prior to or for takeoff; and
e. after landing the aircraft at a touch down location, moving the aircraft with only the engines operating at a reduced throttle setting, activating the electric taxi systems and moving the aircraft during a hybrid taxi-in period with the engines at a lowest throttle setting operating simultaneously with the electric taxi systems to optimally cool the engines, turning off the optimally cooled engines at a taxiway location outside the terminal jet blast margins and ending the hybrid taxi-in period, moving the aircraft with only the electric taxi drive systems to a terminal parking location, and inactivating the electric taxi drive systems.

2. The method of claim 1, wherein the hybrid taxi-out period corresponds to the warm up time requirements for at least two the turbofan engines and the hybrid taxi-in period corresponds to the cool down requirements for the at least two turbofan engines.

3. The method of claim 1, wherein the lowest engine throttle setting comprises a zero throttle setting.

4. The method of claim 1, wherein the warm up time requirements of the at least two turbofan engines comprise 3 to 6 minutes

5. The method of claim 4, wherein the at least two turbofan engines comprise geared turbofan engines and the warm up time requirements comprise 6 minutes.

6. The method of claim 1, wherein components of the at least two turbofan engines comprise at least a plurality of rotor blades circumferentially mounted on a central hub for rotational movement within an engine shroud.

7. The method of claim 6, further comprising warming up the plurality of rotor blades during the hybrid taxi-out period and maintaining tips of each of the plurality of rotor blades at a clearance gap from the engine shroud during engine operation.

8. The method of claim 6, further comprising cooling the plurality of rotor blades without distortion during the hybrid taxi-in period and maintaining the tips of each of the plurality of rotor blades at a clearance gap from the engine shroud during engine operation.

9. The method of claim 7, wherein the clearance gap comprises a tight clearance distance of the tips from the engine shroud comprising less than 0.5% of a blade length of the plurality of rotor blades.

10. The method of claim 9, wherein the clearance gap comprises a very tight clearance distance of the tips from the engine shroud comprising 0.2% of a blade length or 0.1% of a blade length of the plurality of rotor blades.

11. A method that extends aircraft engine run time during taxi out and ensures that aircraft engines requiring a long warm up time are in an optimal thermal state by takeoff without extending aircraft total time on the ground, comprising:
a. providing aircraft equipped with main engines comprising turbofan or geared turbofan engines that require a longer than typical or average warm up time prior to takeoff and equipped with landing gear wheel-mounted electric taxi drive systems controllable to drive the equipped aircraft during ground travel without operation of the main engines and also simultaneously with operation of the main engines;
b. driving the aircraft with only the electric taxi drive systems upon departure beyond an airport terminal to an engine safe start location;
c. starting the main engines and simultaneously operating the main engines at a zero throttle setting while the electric taxi systems continue to drive the aircraft; and
d. driving the aircraft during a hybrid taxi-out period with the simultaneously operating electric taxi drive systems and the main engines at the zero throttle setting and warming up the main engines during the hybrid taxi-out period, arriving at a take off runway location with the main engines in an optimal thermal state, inactivating the electric taxi drive systems, and increasing the throttle setting of the warmed up engines to a taxi throttle setting, a breakaway throttle setting, or a takeoff throttle setting, as required, to move the aircraft to takeoff.

12. The method of claim 11, wherein the hybrid taxi-out period corresponds to the warm up time requirements for the at least two turbofan engines.

13. The method of claim 11, wherein the lowest engine throttle setting comprises a zero throttle setting.

14. The method of claim 12, wherein the warm up time requirements of the at least two turbofan engines comprise 3 to 6 minutes.

15. The method of claim 14, wherein the at least two turbofan engines comprise geared turbofan engines and the warm up time requirements comprise 6 minutes.

16. A method that extends aircraft engine run time during taxi in and ensures that aircraft engines are cooled down time and in an optimal thermal state priori to arrival without extending aircraft total time on the ground, comprising:
a. providing aircraft equipped with main engines comprising turbofan or geared turbofan engines that require a longer than typical or average cool down time and equipped with landing gear wheel-mounted electric taxi drive systems controllable to drive the equipped aircraft during ground travel without operation of the main engines and also simultaneously with operation of the main engines;
b. driving the aircraft upon landing with only the main engines and reducing the throttle setting;
c. activating the electric taxi systems on the moving aircraft and simultaneously operating the main engines at a zero throttle setting and the electric taxi systems; and
d. driving the aircraft during a hybrid taxi-in period with the simultaneously operating main engines at the zero throttle setting and the electric taxi drive systems and cooling the main engines during the hybrid taxi-in period, arriving at a taxiway location with the main engines in an optimal thermal state and safely shutting down the main engines, and continuing to drive the aircraft with only the electric taxi drive systems from the taxiway location to a terminal parking location.

17. The method of claim 16, wherein the hybrid taxi-in period corresponds to the cool down requirements for the at least two turbofan engines.

18. The method of claim 16, wherein the lowest engine throttle setting comprises a zero throttle setting.

19. The method of claim 17, wherein the longer than typical or average warm up time requirements of the at least two turbofan engines comprise 3 to 6 minutes

20. The method of claim 19, wherein the at least two turbofan engines comprise geared turbofan engines and the warm up time requirements comprise 6 minutes.
